(19) United States
(12) Patent Application Publication
(10) Pub. No.: US 2024/0307240 A1
(43) Pub. Date: Sep. 19, 2024

(54) LIFTING AND RECLINING WHEELCHAIR

(71) Applicant: Dustin L. Pereslete, Grand Isle, VT (US)

(72) Inventor: Dustin L. Pereslete, Grand Isle, VT (US)

(21) Appl. No.: 18/604,214

(22) Filed: Mar. 13, 2024

Related U.S. Application Data
(60) Provisional application No. 63/451,846, filed on Mar. 13, 2023.

(51) Int. Cl. A61G 5/10

(52) U.S. Cl. CPC A61G 5/1059

(57) ABSTRACT

A lifting and reclining wheelchair can include a lower frame and a pair of drive wheels rotatably connected to the lower frame and operable by a user to move the wheelchair about an environment. The wheelchair can include an upper frame connected to the lower frame and movable with respect to the lower frame. The wheelchair can include a seat connected to the upper frame and movable with the upper frame relative to the lower frame. The wheelchair can include a backrest connected to the upper frame and movable with the upper frame relative to the lower frame, the backrest configured to recline with respect to the seat. The wheelchair can include a hydraulic lift connected to the lower frame and the upper frame and operable to lift the upper frame with respect to the lower frame between a raised position and a lowered position.

### CLAIM OF PRIORITY

This patent application claims the benefit of priority, under 35 U.S.C. Section 119(e), to Dustin L. Pereslete, U.S. Patent Application Ser. No. 63/451,846, entitled Wheelchair Lifting And Reclining Mobility Platform For Paraplegic Users, filed on Mar. 13, 2023, which is hereby incorporated by reference herein in its entirety.

### BACKGROUND

Many individuals with a disability which, whether permanent or temporary, may be unable to perform daily living activities without assistance from caregivers. Alternatively, or additionally, some people with disabilities use specialized wheelchairs, beds, therapy devices, toilets, and bathtubs for their daily activities. For example, specialized wheelchairs can help paraplegics, and others with similar limitations, to safely ingress and egress from a wheelchair, such as into or onto a bed or other raised platform.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an isometric view of a lifting and reclining wheelchair in a lowered position.

FIG. 2 illustrates a side view of a lifting and reclining wheelchair in a lowered position.

FIG. 3A illustrates an isometric view of a lifting and reclining wheelchair in a raised and seated position.

FIG. 3B illustrates an isometric view of a lifting and reclining wheelchair in a raised and standing position.

FIG. 4 illustrates a side view of a lifting and reclining wheelchair in a raised position.

FIG. 5 illustrates a side view of a lifting and reclining wheelchair in a reclined position.

FIG. 6 illustrates a side view of a lifting and reclining wheelchair in a reclined position.

FIG. 7 illustrates a perspective view of a portion of a lifting and reclining wheelchair.

FIG. 8A illustrates an isometric view of a portion of a lifting and reclining wheelchair in a lowered position.

FIG. 8B illustrates an isometric view of a portion of a lifting and reclining wheelchair in a raised position.

FIG. 9 illustrates a perspective view of a portion of a lifting and reclining wheelchair.

FIG. 10 illustrates a schematic view of a hydraulic system of a lifting and reclining wheelchair.

FIG. 11 illustrates a schematic view of an electrical system of a lifting and reclining wheelchair.

FIG. 12 illustrates a schematic view of an electrical system of a lifting and reclining wheelchair.

FIG. 13 illustrates a chart showing performance of a lifting and reclining wheelchair.

FIG. 14 illustrates a chart showing performance of a lifting and reclining wheelchair.

FIG. 15 illustrates a block diagram illustrating an example of a machine upon which one or more embodiments may be implemented.

### DETAILED DESCRIPTION

Wheelchair users, such as paraplegic users, often need to be able safely and practically ingress and egress from a wheelchair, such as into or onto a bed or other raised platform without the need for additional assistance or risk of injury to themselves or their caregivers. The equipment or device used to accomplish these tasks is preferably reliable, lightweight, easily transported in typical automobiles or public transportation, made from readily available materials and components, and relatively inexpensive. Operation of the device is preferably intuitive and adaptable to specific needs of each user. It is also desirable that the wheelchair can still navigate public wheelchair accessible facilities (or at least those that are compliant with the American Disabilities Act (ADA)), including ramps and doorways. Also, wheelchair users are susceptible to abrasions, cuts, and other injuries during manual transfers into and out of their wheelchairs due to the manual lifting, pulling, and sliding required for the transfer to be completed. Additional equipment is often required to safely complete the transfer such as slings, slide boards, or other mechanical advantage devices. Caregivers and assistants are also susceptible to injury due to the stresses incurred while attempting to lift full body weight of a user during transfer.

This disclosure can help to address these issues by providing a wheelchair configured to safely raise a paraplegic patient in a normal seated position to a desired level that corresponds to a standard range of heights typically found with beds, gurneys, and examination tables using a typical manual wheelchair. The wheelchair(s) of this disclosure is also able raise the legs of a user by extending the knees, as well as reclining a torso of a user to a full laying position or any position required between full upright and full recline while the user is still in the wheelchair. These functions can help to provide safe transfer of the user from the wheelchair onto a corresponding surface, such as a horizontal surface. The wheelchair seat and back can also be tilted forward into a standing configuration through the use of a hydraulic-mechanical lifting and actuation system incorporated into a standard wheelchair frame. This four-function chair can provide improved autonomy for the user and can help to reduce incidence of injury during solo transfers, and can help to provide support and assistance to caregivers during assisted transfers.

The above discussion is intended to provide an overview of subject matter of the present patent application. It is not intended to provide an exclusive or exhaustive explanation of the invention. The description below is included to provide further information about the present patent application.

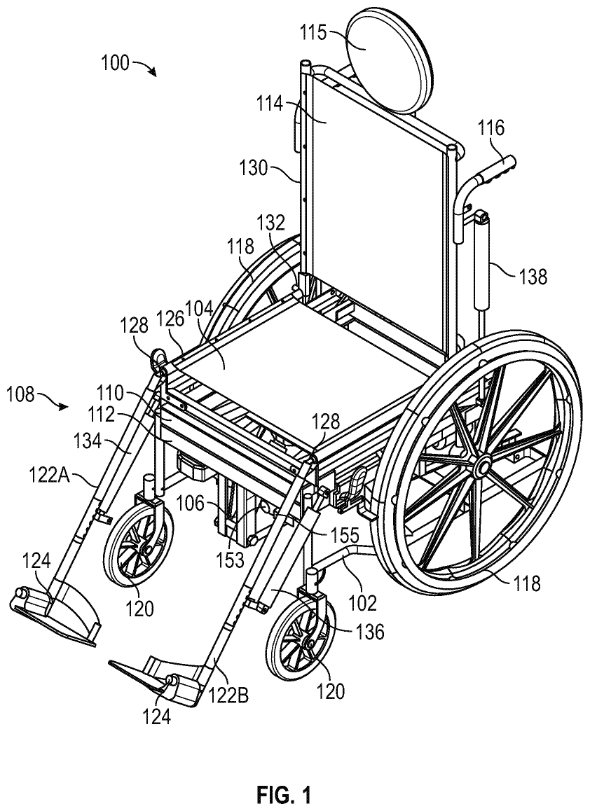

FIG. 1 illustrates an isometric view of a lifting and reclining wheelchair 100 in a lowered position. The lifting and reclining wheelchair 100 (referred to as wheelchair 100) can include a fixed frame 102 connected to a scissor lift mechanism (shown in further detail below) fitted underneath a seat 104 and powered by a primary actuator 106. The seat 104 can be connected to a movable frame 108, such as to an upper portion 110 thereof. A lower portion 112 of the movable frame 108 can be connected to the fixed frame 102. The wheelchair 100 can also include a backrest 114 connected to the upper portion 110 and connected to the seat 104. A head rest 115 can be connected to an upper portion of the backrest 114 and can be configured to support a head of the user. Push handles 116 can be connected to the backrest 114 and can be operable to push the wheelchair 100 about one or more environments. The push handles 116 can be welded to the backrest 114.

The lifting and reclining wheelchair 100 can also include drive wheels 118 (e.g., including a grip ring). The drive wheels 118 can be connected to the fixed frame 102 and can be operable to move the chair, such as by the user, about one or more environments. The wheelchair 100 can include two drive wheels but can include one or three drive wheels in other examples. Similarly, the wheelchair 100 can include casters 120 that can be connected to the fixed frame 102. The casters 120 can be passive wheels configured to, together with the drive wheels 118, support a weight of the wheelchair 100 on a surface (such as a floor or ground). The wheelchair 100 can include two casters but can include 1, 3, 4, 5, 6, or the like casters in other examples. The wheelchair 100 can be either pushed by an assistive caregiver or operated by users who have use of their arm and shoulder muscles. The drive wheels 118 of the wheelchair can be manually driven to conserve weight and reduce complexity. The passive casters 120 can help maintain stability and balance as well as accommodate zero-turn features of a typical manually operated wheelchair.

The wheelchair 100 also includes leg supports 122 that can be connected to the seat 104 at a proximal portion of the leg supports 122, and thereby the leg supports 122 can be connected to the upper portion 110. Foot rests 124 can be connected to a distal portion of the leg supports 122 and can be configured to receive and support feet of a user at least partially therein. Optionally, the foot rests 124 can be rotatable with respect to the leg supports 122.

The seat 104 can include a frame 126 configured to support a weight of the seat 104 (and also the user). The seat frame 126 can be connected to the leg supports 122, such as via one or more joints or hinges 128. Similarly, the backrest 114 can include a frame 130 configured to support a weight of the backrest 114 (and also the user). The backrest frame 130 can be connected to the frame 126, such as via one or more joints or hinges 132. The joints 128 and 132 can allow the leg supports 122, the frame 126, and the frame 130 to pivot or rotate to move between a seating position, a lying position, and a standing position, as discussed in further detail below.

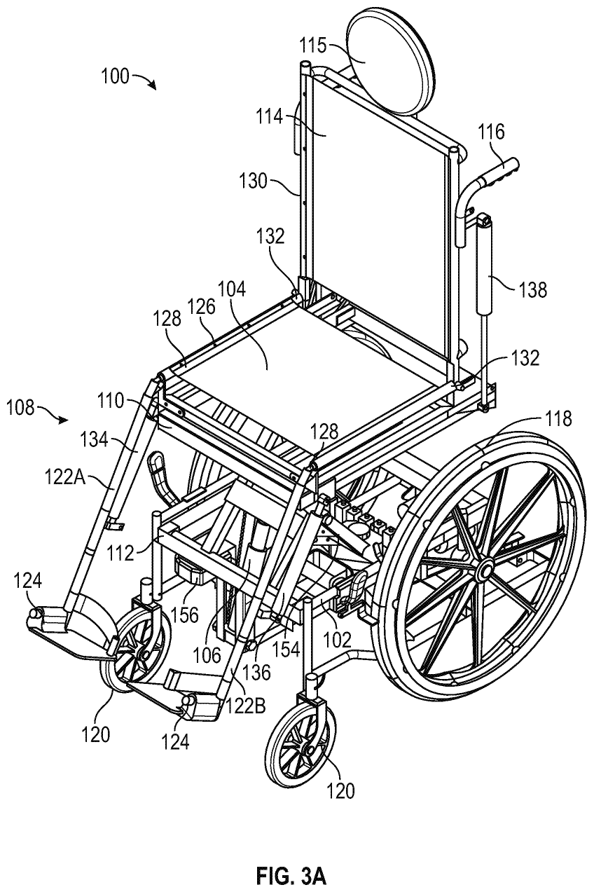

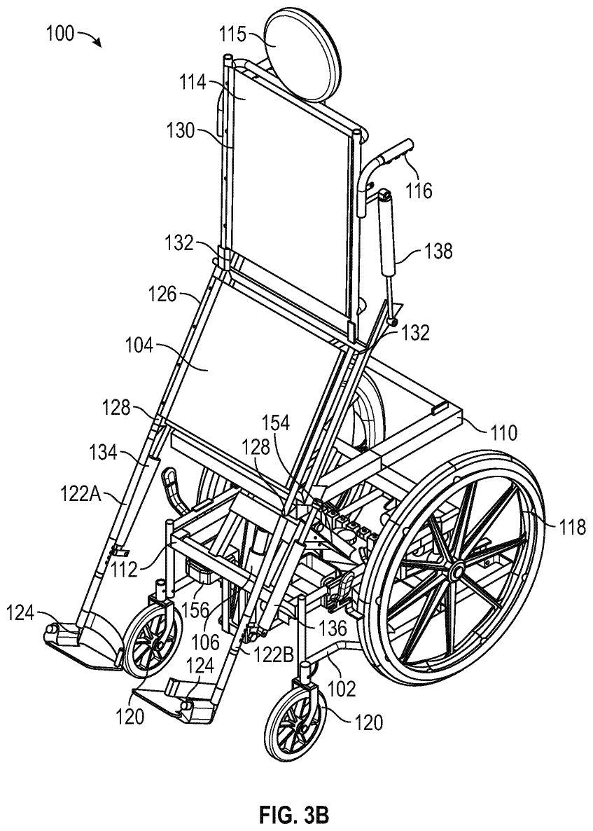

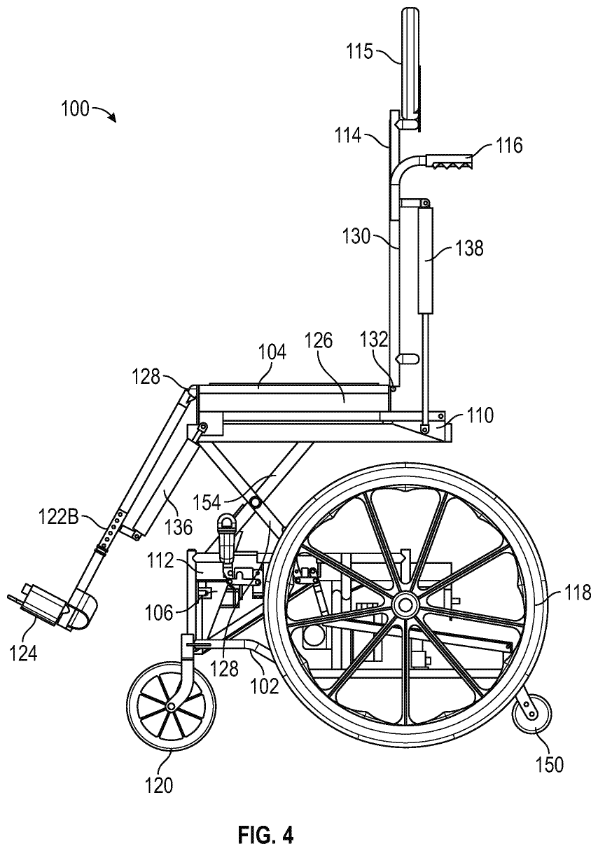

The wheelchair 100 can also include additional actuators. For example, the wheelchair 100 can include leg support actuators 134 and 136 that can be connected to the leg rests 122a and 122b, respectively. The leg support actuators 134 and 136 can also be connected to the upper portion 110 of the movable frame 108. The wheelchair 100 can also include back rest actuators 138 and 140 (only back rest actuator 138 is visible in FIG. 1). The actuators (including the primary actuator 106) can be used to move the wheelchair 100 between the various positions of the wheelchair 100 where movement of the components of the wheelchair 100 can be guided by the joints (e.g., the hinges 128 and the hinges 132) and a scissor lift (discussed in further detail below). For example, as shown in FIG. 1, the wheelchair 100 can be in a seated and lowered position or configuration and the actuators can be operated to move the wheelchair 100 to the raised position of FIGS. 3-4.

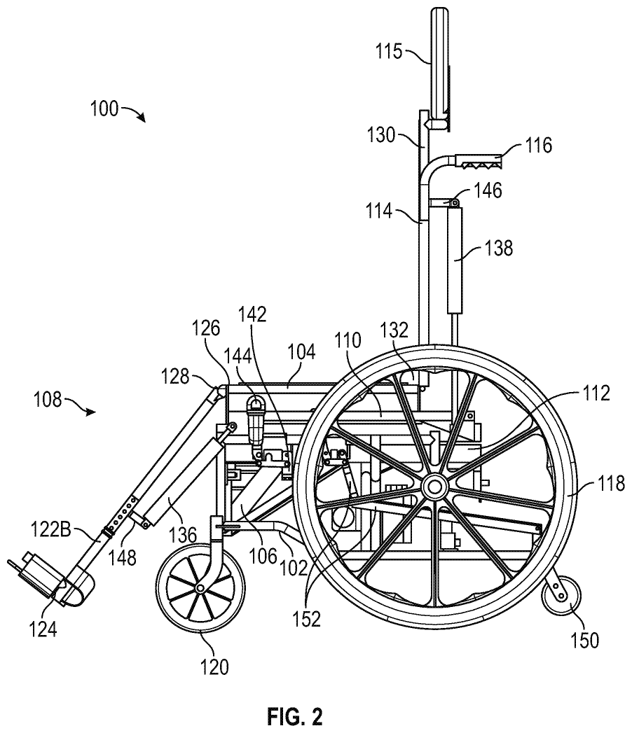

FIG. 2 illustrates a side view of the lifting and reclining wheelchair 100 in a lowered position. The wheelchair 100 can be consistent with FIG. 1 discussed above; FIG. 2 shows additional details of the wheelchair 100. For example, FIG. 2 more clearly shows the primary actuator 106 connected to a lower portion of the fixed frame 102. The primary actuator 106 can provide a total vertical displacement of 40 to 45 centimeters. FIG. 2 also shows a brake 142 connected to the fixed frame 102 and configured to engage with the drive wheels 118 to slow or stop the wheelchair 100 from rolling or moving. The wheelchair 100 can also include a brake handle 144 that can be connected to the brake 142 and operable to move the brake 142 between an engaged position and a disengaged position. Optionally, the brake 142 and handle 144 can be biased towards the disengaged position. Optionally, the brake 142 and handle 144 can be lockable via an over-center cam mechanism.

FIG. 2 also shows that the back rest actuators 138 can be secured to the frame 130 by one or more standoffs 146. The standoffs 146 can be welded (or otherwise fastened or secured) to the frame 130 and the back rest actuators 138 and 140 can be pivotably connected to the one or more standoffs 146 such as via a bearing (e.g., a journal bearing or a ball bearing). The back rest actuators 138 and 140 can also be pivotably connected to the upper portion 110 by a bearing. The leg support actuators 134 and 136 can also be pivotably connected to the leg supports 122 by standoffs 148. And, the leg support actuators 134 and 136 can be pivotably connected to the upper portion 110.

FIG. 2 also shows that the wheelchair 100 can include a stabilization wheel 150 that can be connected to the fixed frame 102 (and optionally to the lower portion 112) by a linkage 152. The stabilization wheel 150 can be deployed by the linkage 152, such as via a handle to prevent (or limit) the wheelchair 100 from tipping backwards when the occupant is reclining and a center of gravity (COG) shifts rearward relative to the fixed frame 102.

FIG. 3A illustrates an isometric view of a lifting and reclining wheelchair in a raised position. FIG. 3B illustrates an isometric view of a lifting and reclining wheelchair in a raised position and standing position. FIGS. 3A and 3B are discussed together below. The wheelchair 100 can be consistent with FIGS. 1-2 discussed above; FIG. 3A shows the wheelchair 100 in an elevated configuration or position. To achieve such a configuration, the primary actuator 106 can be operated to drive the upper portion 110 and lower portion 112 to separate vertically, where such movement can be guided by a scissor lift 154. The scissor lift 154 can be connected to the lower portion 112 and the upper portion 110 of the movable frame 108 and can control or limit vertical movement of the upper portion 110 with respect to the lower portion 112 as driven by the primary actuator 106.

FIGS. 3A and 3B also show how the wheelchair 100 can be moved from the seated configuration of FIG. 3A to the standing configuration of FIG. 3B. As shown in FIG. 3A, the leg support actuators 134 and 136 can be retracted such that the leg supports 122 are angled with respect to the seat 104. When the wheelchair 100 is moved to the standing configuration, the leg support actuators 136 can be operated to extend to straighten the leg supports 122 with respect to the seat 104 where such movement can be enabled by the hinges 128.

Also, as shown in FIG. 3A, when the wheelchair 100 is in the seated position, the back rest actuators 138 and 140 can be fully extended and the backrest 114 and seat 104 can be at a relative angle of about 90 degrees. When the wheelchair 100 is moved to the standing position, the back rest actuators 138 and 140 can be operated to increase an angle between the seat 104 and the backrest 114 where such relative movement can be enabled by the hinges 132 connected to the frame 126 and the frame 130.

FIGS. 3A and 3B also show a mounting location of a battery 156, which can be configured to operate or provide power to a hydraulic motor to drive the actuators (e.g., the primary actuator 106, the leg support actuators 134 and leg support actuators 136, and the back rest actuators 138 and 140. The battery 156 can connected to the chair via an adapter that provides quick release of the battery 156. Optionally, the adapter can be configured to receive a common cordless drill battery.

The seat 104 and the backrest 114 can be made of fabric stretched across the frame 126 and the frame 130, respectively, to help increase pliability and occupant comfort. The headrest 115 can be mounted to the frame 130 and can be covered with fabric over a foam core. The headrest 115 can be made to be adjustable (e.g., in relative position to the backrest 114), to help increase occupant comfort. In the fully raised position, the occupant has easy access to an emergency machine off push button switch 153 (E.M.O.) located on the lower left half of the scissor lift frame. Located next to the EMO switch is the main power toggle switch 155.

Optionally, the wheelchair 100 can include an additional actuator that can be connected to the upper portion 110 and to the frame 126 that can be hydraulically powered to cause the seat 104 to extend to the position shown in FIG. 3B. In such a situation, the wheelchair 100 can include two more hydraulic valves (discussed below) to accommodate the additional actuator.

FIG. 4 illustrates a side view of the lifting and reclining wheelchair 100 in a raised position. The wheelchair 100 of FIG. 4 can be consistent with FIGS. 1-3B discussed above; FIG. 4 shows the wheelchair 100 in an elevated configuration or position, which more clearly shows the scissor lift 154 connected to the upper portion 110 and the lower portion 112. The scissor lift 154 can be pivotably and slidably connected to the upper portion 110 and the lower portion 112 to allow vertical movement of the upper portion 110 with respect to the lower portion 112, which can be dictated by the primary actuator 106. FIG. 4 also more clearly shows that the leg supports 122 can each include two tubes, with one fitting inside the other, and including six designated detent locking points via a spring loaded hole and pin design for each footrest, which can be user-operable to allow for length adjustment of the leg supports 122.

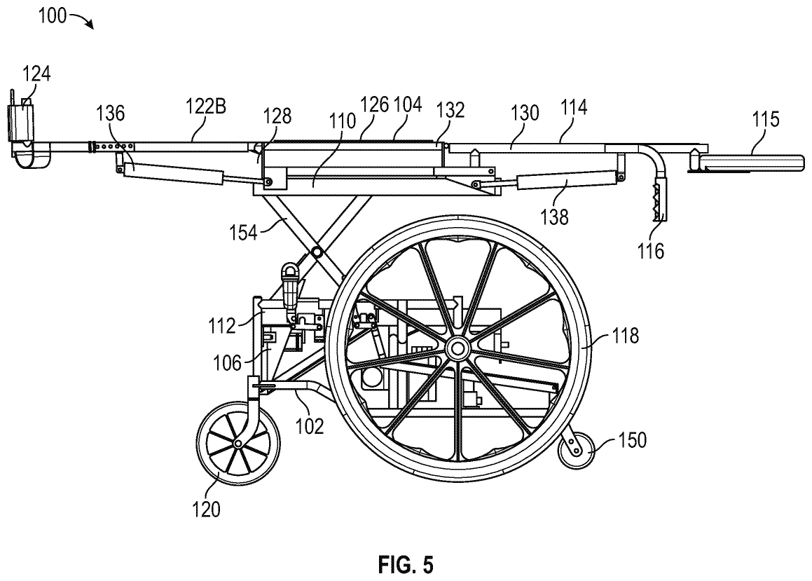

FIG. 5 illustrates a side view of a lifting and reclining wheelchair in a reclined position. The wheelchair 100 of FIG. 5 can be consistent with FIGS. 1-4 discussed above; FIG. 5 shows the wheelchair 100 in an elevated and reclined configuration or position. In this position (elevated and reclined), the leg support actuators 134 and 136 and the primary actuator 106 can be fully extended. The stabilization wheel 150 can also be deployed to limit backwards tipping due to the COG shift of the wheelchair 100 and the occupant in the fully reclined position. The recline function can be electrically interlocked such that the occupant cannot recline unless the stabilization wheel 150 is deployed.

The back rest actuators 138 can rotate the backrest 90 degrees from fully vertical to the fully horizontal about the hinges 132 that attach the frame 130 to the frame 126. The attachment points between the back rest actuators 138 and 140 and the upper portion 110 and between the back rest actuators 138 and 140 and the frame 130 can be a pin and shackle type configuration, allowing the necessary rotation about their respective axes. The leg support actuators 134 and the leg support actuators 136 can rotate the leg supports 122 about 60 degrees from a seated position to a straight or horizontal position (shown in FIG. 5) about the hinges 128 that attach the leg supports 122 to the frame 126. The attachment points between the leg support actuators 134 and 136 and the upper portion 110 and between the leg support actuators 134 and 136 and the leg supports 122 can be a pin and shackle type configuration, allowing the necessary rotation about their respective axes.

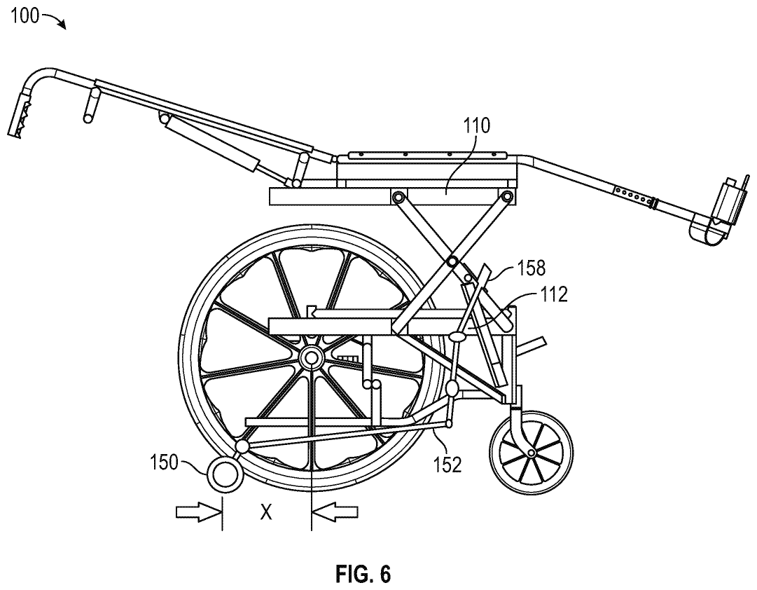

FIG. 6 illustrates a side view of the lifting and reclining wheelchair 100 in a reclined position. The wheelchair 100 of FIG. 6 can be consistent with FIGS. 1-5 discussed above; FIG. 6 shows how the stabilization wheel operates. As shown in FIG. 6, the stabilization wheel 150 can be moved to the deployed position (shown in FIG. 6) from the retracted position by operating a handle 158 that is connected to the linkage 152 and to the lower portion 112 or the fixed frame 102. When the stabilization wheel 150 is moved to the deployed position, the stabilization wheel 150 can help to accommodate a center of gravity that moves rearward, such as from under the rotation point of the wheels, by a distance of X, which can help to reduce tipping in the reclined position.

The stabilization wheel 150 can be electrically interlocked so that the recline function will not operate (e.g., the hydraulic valves of the back rest actuators 138 and 140 will not actuate) with a remote control input unless the wheel is fully deployed. Operation of the stabilization wheel 150 can be initiated by actuating the mechanical lever 158 on a left side of the lower portion 112 by pushing it forward. This actuation through a set of linkages and pivot points causes the stabilization wheel 150 to rotate about its attachment linkage down until it contacts the floor or deck. An over-center cam lock can maintain the stabilization wheel 150 in the deployed position until the operator returns the actuation lever 158 to its original position and non-deployed position.

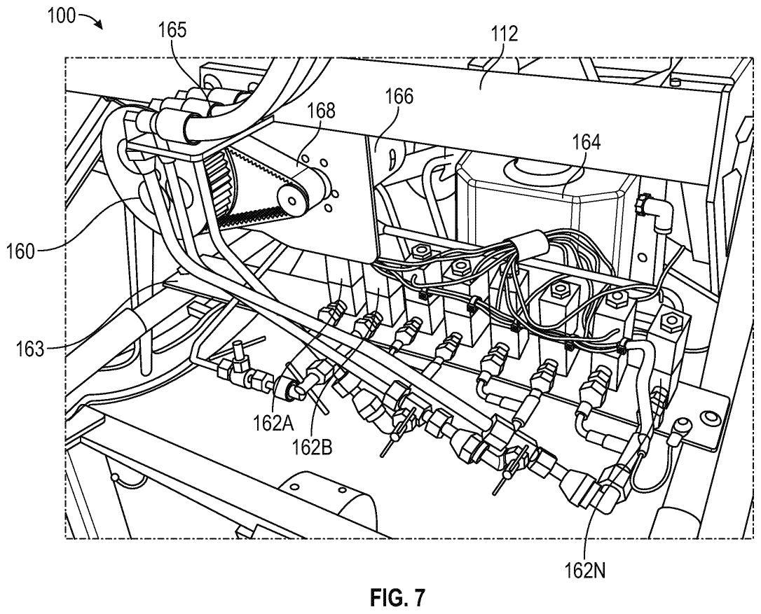

FIG. 7 illustrates a perspective view of a portion of a lifting and reclining wheelchair 100. The wheelchair 100 of FIG. 7 can be consistent with FIGS. 1-6 discussed above; FIG. 7 shows how some of the hydraulic components of the wheelchair 100 can be mounted, arranged, or secured. For example, FIG. 7 shows that a hydraulic pump 160 can be secured to the lower portion 112 as can a plurality of hydraulic valves 162a-162n (collectively referred to as hydraulic valves 162), and a hydraulic reservoir 164. The hydraulic pump 160 can be a gear pump, a piston pump, a vane pump, or the like. The hydraulic valves 162 can be connected to the hydraulic pump 160 and the various actuators by hard lines, such as copper, or flexible lines capable of accommodating hydraulic pressures (e.g., 3000 to 4000 kilopascals (kPa)). For example, braided metallic lines, or metallic reinforced polymer lines can be used. In some examples, fixed hydraulic lines 163 can connect the components that are fixed in relation to the wheelchair frame 102, such as the hydraulic pump 160 and the hydraulic valves 162, and flexible hydraulic lines 165 can be connected to all components that require relative motion to execute functions, such as the back rest actuators 138 and 140.

The hydraulic pump 160 can be driven by a motor 166, which can be a DC motor powered by the battery 156. The motor 166 can be connected to the hydraulic pump 160 by a belt 168. The hydraulic pump 160 and the motor 166 can be mounted under the lower portion 112 in close proximity to keep a size or length of the belt 168 relatively short. Optionally, the hydraulic pump 160 and the motor 166 can be connected via a set of pulleys and belts to reduce the relative motor to pump revolutions per minute (RPM) by a factor of about 7.5 to achieve a safe lifting time of about 7 seconds. However, the system can be optimized or designed to other lift times such as between 3 and 15 seconds, between 5 and 10 seconds, or the like. In other examples, the hydraulic pump 160 can be directly driven.

The hydraulic reservoir 164 can be a tank connected to the hydraulic pump 160 and the hydraulic valves 162, as discussed in further detail below, and can be connected to atmospheric pressure. The hydraulic reservoir 164 can be configured to receive and store a relatively large volume of hydraulic fluid sufficient to operate all of the actuators of the wheelchair 100 (meaning to at least fill all of the lines with hydraulic fluid). The hydraulic fluid can be a mineral oil, petroleum fluid, a synthetic fluid, or other common hydraulic fluids. In some examples, the wheelchair 100 can be configured to use non-toxic and incompressible vegetable oil.

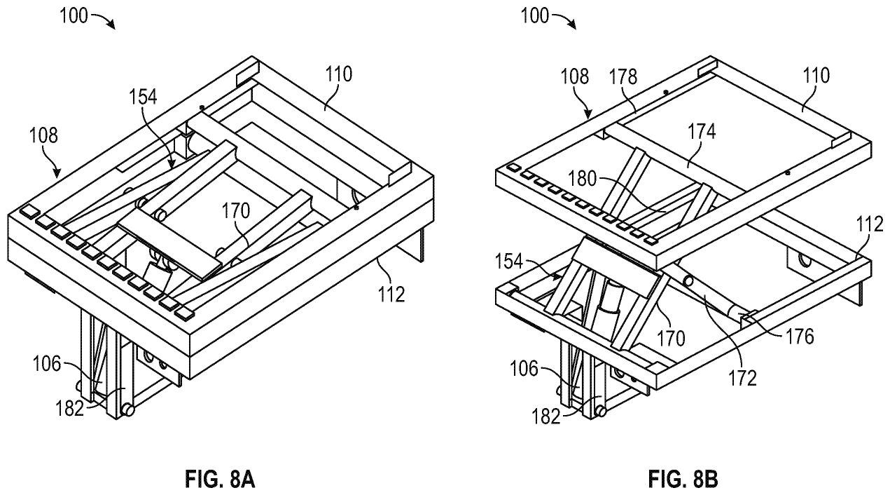

FIG. 8A illustrates an isometric view of the movable frame 108 of the lifting and reclining wheelchair 100 in a lowered position. FIG. 8B illustrates an isometric view of the movable frame 108 of the lifting and reclining wheelchair 100 in a raised position. FIGS. 8A and 8B are discussed together below. The wheelchair 100 of FIGS. 8A and 8B can be consistent with FIGS. 1-7 discussed above; FIGS. 8A and 8B show how the movable frame 108 can operate.

For example, the upper portion 110 can serve as a central mounting point for the seating accommodations, such as the seat 104, the backrest 114, and the leg supports 122. The lower portion 112 can be attached to the fixed frame 102 and can support the primary actuator 106. More specifically, FIG. 8A shows the movable frame 108 in a collapsed or lowered configuration and FIG. 8B shows the movable frame 108 in a raised elevated configuration. FIGS. 8A and 8B also show that the scissor lift 154 can include crossing links 170 and 172, which can be pivotably connected to each other. A front section of crossing links 170 and crossing links 172 can be linearly fixed and can allow only rotation of the scissor links. A rear portion of the links 170 and 172 can be connected to sliding bars 174 and 176, respectively, which can translate along tracks 178 and 180, respectively, as the scissor lift 154 moves the upper portion 110 relative to the lower portion 112. A set of four nylon friction blocks can be connected to ends of the sliding bars 174 and the sliding bars 176 to help reduce friction and to promote sliding along the tracks 178 and 180. FIGS. 8A and 8B also show that the wheelchair 100 can include a lift support 182 connected to the lower portion 112 where the primary actuator 106 is pivotably connected to the lift support 182 and is connected to the crossing links 170 of the scissor lift 154.

In operation of some examples, the primary actuator 106 can be in a retracted position such that the upper portion 110 rests on the lower portion 112 and the wheelchair 100 is in the lowered position. When it is desired to move the seat 104 to the elevated position, the hydraulic pump 160 can be operated to drive the crossing links 170 upward, causing the sliding bars 174 to translate forward along the track 178 and causing the sliding bars 176 to translate forward along the track 180, such that the sliding bars 174 and 176 and the tracks 178 and 180 guide or limit a range of motion of the scissor lift 154. For example, the upper portion 110 can reach an upper limit when the sliding bars 174 or the sliding bars 176 engage an end of their respective tracks 178 and 180. The scissor lift frame is constructed of lightweight aluminum and is rated for a maximum 400 lbs lift.

The primary actuator 106 can be configured to lift the components of the wheelchair 100 plus a 136 kilogram (kg) or 300 pound occupant about 40 centimeters (cm) vertically to a total deck height of 91 cm in the raised position or configuration. The maximum height can be determined or dictated by mechanical throw of the primary actuator 106. The wheelchair 100 can include a primary actuator and scissor lift with a larger weight capacity or lift height in some examples, and can be modified to include a primary actuator and scissor lift with a smaller capacity and lift height (or any combination thereof) based on the needs of the user.

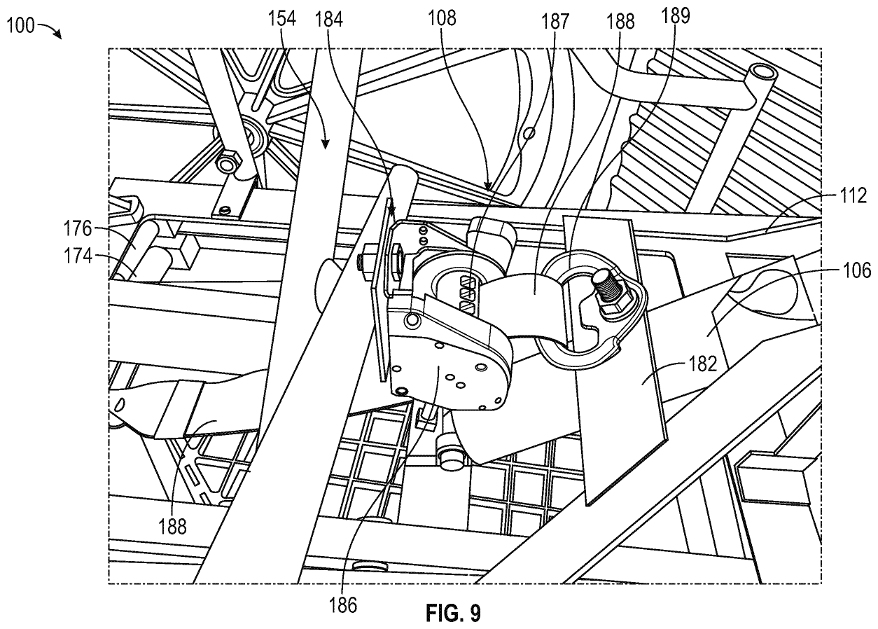

FIG. 9 illustrates a bottom perspective view looking upward of a portion of the lifting and reclining wheelchair 100. The wheelchair 100 of FIG. 9 can be consistent with FIGS. 1-8B discussed above; FIG. 9 shows how the lift safety mechanism can be attached to the wheelchair frame and connected to the lower scissor lift frame to help prevent the upper scissor lift frame from dropping suddenly and injuring the occupant.

More specifically, a safety device 184 can be connected to the sliding bars 176 of the scissor lift 154. The safety device 184 can include a locking device 186 secured to the sliding bars 176 and a strap 188. The strap can be configured to rotate around a portion of the locking device, which can include an inertia wheel 187 and one or more pawls and teeth. An end of the strap 188 can be secured to the inertia wheel 187 and the other end of the strap can be secured to the sliding bars 176. The strap 188 can be routed through a loop 189, which can be a metal ring, a snatch block, a pulley, or the like, and can be configured to re-route the strap 188 in an opposite direction from the inertia wheel 187.

The safety device 184 can be used in operation to help protect an occupant from injury from a sudden hydraulic fluid depressurization event that could allow the upper portion 110 to vertically drop suddenly. During normal operation, the strap 188 can reel and unreel over the inertial wheel 187 as it freely spins with the linear movement of the scissor lift 154 as the scissor lift 154 is lowered and raised. In the event of a sudden vertical drop, the sliding bars 176 will attempt to accelerate quickly away from the lower portion 112, which can cause a pawl connected to the inertia wheel 187 to angularly accelerate such that its pawl exceeds its retaining spring force and engages against housing teeth to prevent any further rotation. This rotational lock can prevent any further unreeling of the strap 188 and thus any further linear motion of the sliding bars 176 and therefore the scissor lift 154, effectively locking the scissor lift 154 in its last position just after hydraulic pressure was lost. The inertial wheel 186 can only be unlocked if the tension acting on the nylon strap 188 is relieved either by restoration of the hydraulic system or removal of the occupant from the lift altogether by another means.

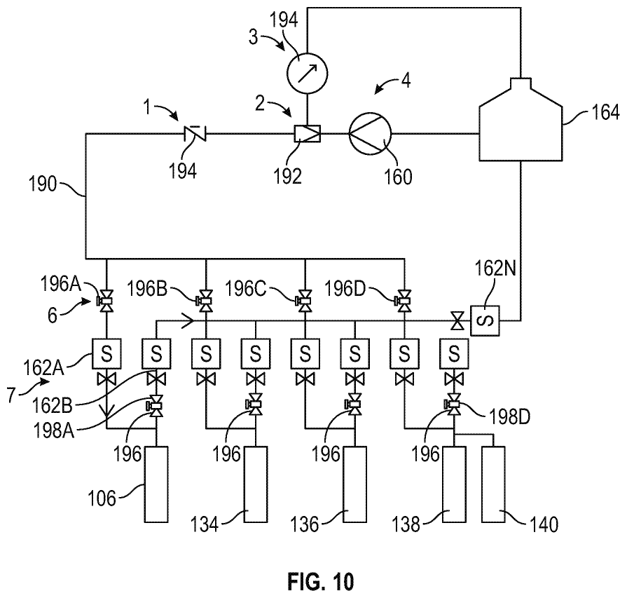

FIG. 10 illustrates a schematic view of a hydraulic system of the lifting and reclining wheelchair 100. The wheelchair 100 can include a hydraulic circuit 190 to which the hydraulic pump 160 and the hydraulic reservoir 164 can be connected. The hydraulic reservoir 164 can be located upstream of the hydraulic pump 160 and can be at atmospheric pressure. The wheelchair 100 can also include a pressure relief valve 192 and a pressure gauge 195 that can be connected to the hydraulic circuit 190 downstream of the hydraulic pump 160. The pressure relief valve 192 can also be connected to the hydraulic reservoir 164. The wheelchair 100 can also include a check valve 194 located downstream of the pressure relief valve 192. Each of the components connected to the hydraulic circuit 190 can be rated for 2 to 3 times the operating pressure, such as at 5000 to 7500 kPa. A volume of the hydraulic reservoir 164 can be large enough to accommodate all five hydraulic cylinders being full or empty simultaneously without overflowing or fluid-starving the system.

The wheelchair 100 can also include the hydraulic valves 162a-162n, which can be in communication with a controller and can be operated (e.g., electrically actuated or operated) to directly flow of hydraulic fluid from the hydraulic pump 160 to the actuators, such as the primary actuator 106, the leg support actuators 134 and 136, and the back rest actuators 138 and back rest actuators 140. On the high pressure side of the hydraulic circuit 190, the wheelchair 100 can also include flow control valves 196a-196d. Each of the flow control valves 196a-196d can be located upstream of one high pressure hydraulic control valve 162 and can be a manual valve or an electronically controlled valve configured to be set to a maximum flow rate deliverable to each of the high pressure hydraulic valves 162 and therefore to each of the actuators. By controlling a flow rate to the actuators, the flow control valves 196a-196d can control a rate of movement of the actuators to their extended positions. The flow control valves 196a-196d can be set individually (to desired flow rates or movement rates) or can all have the same flow rate.

The wheelchair 100 can also include flow control valves 198a-198d, which can be located downstream of one or more actuators and upstream or downstream of one low pressure hydraulic control valve 162. Each of the flow control valves 198a-198d can be a manual valve or an electronically controlled valve configured to be set to a maximum flow rate deliverable from each of the actuators to the hydraulic reservoir 164. By controlling a flow rate from the actuators, the flow control valves 198a-198d can control a rate of movement of the actuators to their retracted positions. The flow control valves 198a-198d can be set individually (to desired flow rates or movement rates) or can all have the same flow rate. Similarly, the flow control valves 198a-198d can all have the same flow rate as the flow control valves 196a-196d.

In operation of some examples, the hydraulic pump 160 can be activated whenever it is desired or required to extend one of the actuators. For example, when there is a call to move the seat 104 to the raised position, the hydraulic pump 160 can be enabled to pump hydraulic fluid from the hydraulic reservoir 164 at approximately 2400 kPa. The system (e.g., a controller) can also operate the hydraulic valve 162a to open to cause the primary actuator 106 to extend and raise the seat 104 (and all other components connected to the upper portion 110 of the movable frame 108). The hydraulic pump 160 can continue to run until the scissor lift 154 reaches its end of travel, which will instantaneously drive up the pressure requirements allowing or causing the hydraulic pump 160 to drive up discharge pressure. Once a limit of the pressure relief valve 192 is reached, which can be, for example, about 3500 kPa, the pressure relief valve 192 can open and flow can be diverted to the hydraulic reservoir 164, limiting or preventing further movement of the primary actuator 106. At this point, the hydraulic pump 160 can be disengaged and the hydraulic valve 162A can be closed, holding the hydraulic pressure within the primary actuator 106 and maintaining a position or configuration of the primary actuator 106 and therefore the movable frame 108. When a call to move from the raised position is received, the hydraulic valve 162B can be opened, allowing hydraulic fluid to move from the primary actuator 106 to the hydraulic reservoir 164. Because the pressurized fluid within the hydraulic circuit 190 upstream of the hydraulic reservoir 164 is much higher than the atmospheric pressure of the hydraulic reservoir 164, the fluid can flow from the primary actuator 106 to the hydraulic reservoir 164 without use of the hydraulic pump 160.

Each of the leg support actuators 134 and leg support actuators 136 and the back rest actuators 138 and back rest actuators 140 can be similarly operated such that the hydraulic pump 160 and the hydraulic valves 162 can be used to extend and retract the actuators to move the various moving components of the wheelchair 100 into the various configurations of the wheelchair 100. Optionally, as shown in FIG. 10, the back rest actuators 138 and back rest actuators 140 can be connected to a common circuit (e.g., to a single pair of high pressure and low pressure valve) to allow the back rest actuators 138 and 140 to move in unison, allowing the backrest 114 to move uniformly between the upright position and the down or reclined position. Optionally, as shown in FIG. 10, the leg support actuators 134 and the leg support actuators 136 can be connected to separate or independent hydraulic valves 162 allowing the leg support actuators 134 and 136 to be operated independently. This can allow the leg supports 122 to be moved or operated independently to accommodate ideal or desire lower limb movements or placements. In other versions, such as to reduce cost, the leg support actuators 134 and 136 can be on the same circuit, i.e., connected to one high pressure and one low pressure hydraulic valve 162 such that the leg supports 122 would move together. While functionality would be reduced, cost and weight could also be reduced.

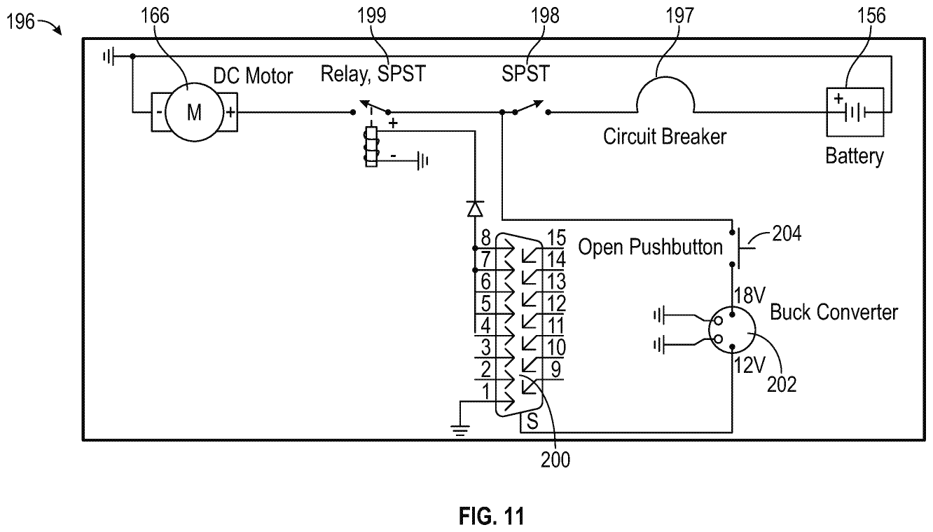

FIG. 11 illustrates a schematic view of an electrical system 196 of the lifting and reclining wheelchair 100. The electrical system 196 can include the battery 156, which can be an 18 VDC battery configured to power the components of the wheelchair 100. The electrical system 196 can also include a circuit breaker 197 and a stop start switch 198. A stop start relay 199 can also be located between the battery and the motor 166 and between a controller 200 and ground so that when the stop start switch or relay are activated, the entire circuit, including the controller 200 are isolated from the battery 156.

The controller 200 can be a relay control board, programmable controller, such as a single or multi-board computer, a direct digital controller (DDC), a programmable logic controller (PLC), printed circuit board (PCB), or the like. In other examples the controller 200 can be any computing device, such as a handheld computer, for example, a smart phone, a tablet, a laptop, a desktop computer, or any other computing device including a processor, memory, and communication capabilities. The electrical system 196 can also include a converter 202 that can be an 18 VDC to 12 VDC buck converter that can consolidate the connections to the hydraulic solenoids, battery, and pump motor, and can supply 12 VDC power to the controller 200 and its 12 VDC operating system.

The battery 156 can be any readily available 4 amp-hour (or the like) cordless drill 18V DC battery that can be sourced from multiple vendors by several well-known manufacturers. The electrical system 196 (and generally the wheelchair 100) can be energized by the switch 198, which can be a toggle switch. The system can be de-energized using the switch 198 and can be quickly de-energized using an emergency machine off switch 204, which can be a plunger or other push-button that is relatively easy to access and actuate. Power to the motor 166 can be routed through the relay 199, which can receive its signal from the controller 200. The circuit breaker 197 can be, for example, a 30 amp circuit breaker configured to protect the motor loop from overcurrent.

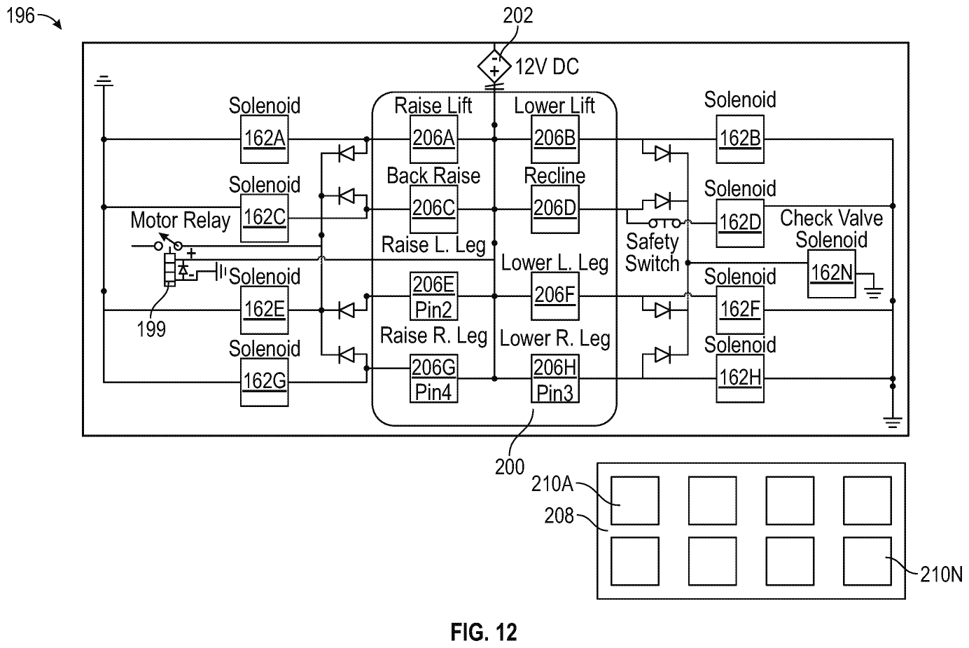

FIG. 12 illustrates a schematic view of the electrical system 196 of the lifting and reclining wheelchair 100. The wheelchair 100 and the electrical system 196 can be consistent with FIGS. 1-11 discussed above; FIG. 12 shows additional details of the electrical system 196. For example, FIG. 12 shows that the controller 200 can include relays 206A-206H (collectively referred to as relays 206) associated with respective valves 162A-162H and configured to control operation (i.e., power delivery to) the hydraulic valves 162.

The controller 200 provides 12 VDC signals to electrical solenoids that are part of or are mounted to the hydraulic valves 162. These signals can open and close the hydraulic valves 162 to direct fluid flow to the desired locations. The controller 200 can also be configured to receive wireless signals from a wireless remote control 208, such as radio frequency (RF) signals. However, the controller 200 can be configured to receive various other types of wireless signals such as infrared (IR), bluetooth, and other wireless data networks (e.g., Wi-Fi, 3G, and 4G LTE/LTE-A or 5G networks). Though the wireless remote control 208 is discussed as being a remote control, the wireless remote control 208 can be wired to the controller 200 and mounted, for example, on an armrest of the wheelchair 100. Optionally, the wireless remote control 208 can be another device such as a mobile phone, tablet, other controller, or the like.

The controller 200 can receive 12V DC power from the converter 202 when the switch 198 is enabled. The controller 200 can then receive wireless signals from the handheld wireless remote 208 to activate on or more of the relays 206, where the wireless remote control 208 can transmit to the controller 200 a different signal based on which of the eight function buttons 210 on the remote are activated. The four relays on the left, 206A, 206C, 206E, and 206G, can control the four high fluid pressure functions, i.e., raise the seat 104, raise the backrest 114, raise the leg support 122A, and raise leg support 122B. The output of each of the relays 206 can be connected to its corresponding hydraulic solenoid control coil to control fluid flow from the hydraulic pump 160 to the corresponding hydraulic cylinder or actuator.

To help reduce battery usage and to help reduce ambient noise, the hydraulic pump 160 can be operated only when a function signal is received by the controller 200, rather than having the hydraulic pump 160 run continuously. This is achieved by connecting the relay power outputs in parallel to the relay 199 such that when any of the four high pressure functions are activated, the hydraulic pump 160 is simultaneously enabled. To help prevent unintentional activation of the other three high pressure functions through motor relay current feedback, diodes are placed at the output terminals of each relay 206 such that the diodes block the feedback current path.

The four relays (206B, 206D, 206F, and 206H) on the right can control the four low pressure functions: lower the primary actuator 106, recline the backrest 114, lower the leg support 122A, and lower the leg support 122B. Each relay output can be connected to its corresponding hydraulic solenoid control coil (i.e., corresponding to 162B, 162D, 162F, and 162H, respectively) to control fluid flow from the corresponding hydraulic cylinder to the hydraulic reservoir 164. The check valve solenoid 162N can be a hydraulic solenoid valve between the reservoir 164 and all four low pressure solenoids, and can be used to provide safety redundancy to help prevent unintended cylinder pressure leak down in the event one of the low pressure solenoids fails to close or develops a seal failure. To help prevent the unintentional activation of the other three low pressure functions through the check valve solenoid current feedback, diodes can be connected to the output terminals of each relay to block the feedback current path.

The back recline relay 206D output can be connected to a contact safety switch 212 that is physically connected to the deployment lever 158 of the stabilization wheel 150. This safety switch 212 can help to prevent the release of hydraulic fluid from the back rest actuators 138 and 140 when the stabilization wheel 150 is not deployed, which can help to prevent the wheelchair 100 from tipping.

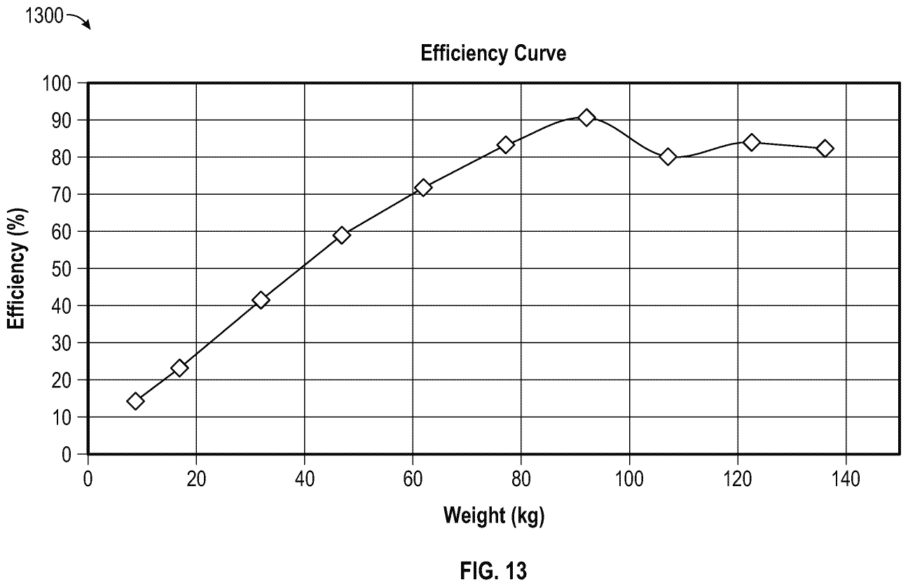

FIG. 13 illustrates a chart 1300 showing performance of a lifting and reclining wheelchair. FIG. 13 graphically demonstrates how the wheelchair lifting system becomes more efficient as occupant weight increases. As the weight increases, the percentage of energy used to overcome system friction decreases.

More specifically, the Y axis depicts machine electrical power efficiency that was derived from motor voltage and current measurements during lifting operations of the wheelchair 100. The X axis depicts a range of weights from 0 to 140 Kg. 137 Kg, or 300 lbs, is the rated lifting capacity of the chair; however, the wheelchair 100 can have a higher rating in other examples by increasing a thickness of the frame (e.g., the fixed frame 102, and a capacity of the scissor lift 154). A series of lift tests were performed, with each data point on the graph representing a test. The plot shows a maximum efficiency of 90% at 93 Kg. In general, the trendline of the efficiency curve increases with increasing weight, suggesting that at lower weights, most of the energy expended is to overcome friction, but as the weight increases, the percentage of energy lost to friction reduces. It can be concluded that as weight is increased, a higher percentage of the energy expended is used to lift the weight, which underscores the efficiency of the scissor lift 154, the hinges, and the hydraulic system that drives movement of the wheelchair 100.

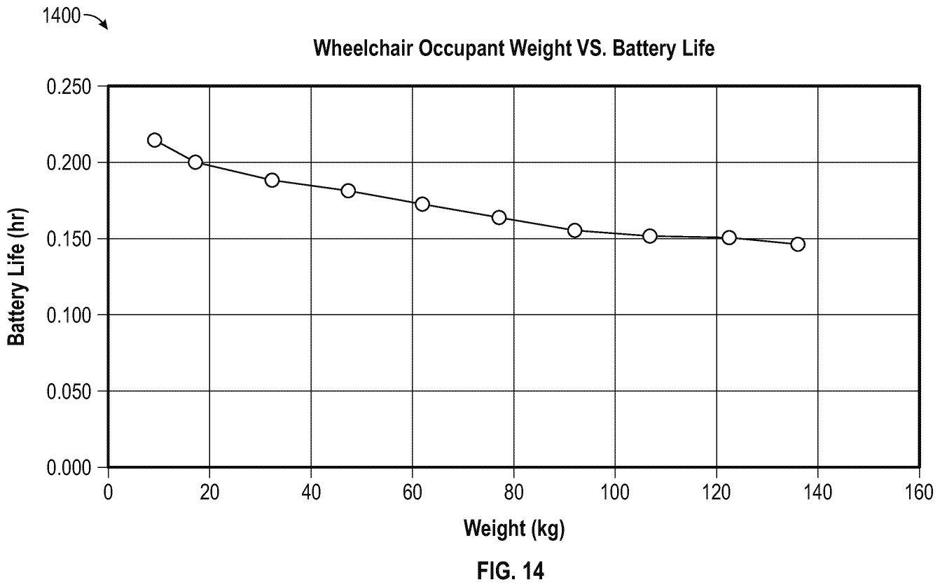

FIG. 14 illustrates a chart 1400 showing performance of a lifting and reclining wheelchair. The graph demonstrates how as occupant weight increases, battery life decreases by about 30 percent from no weight in the chair to the maximum occupant weight of 137 Kg. The Y axis depicts battery life in hours determined based on battery voltage, lift time, and motor current measurements during lifting operations of the wheelchair 100. The X axis depicts a range of weights from 0 to 140 Kg. 137 Kg, or 300 lbs, is the rated lifting capacity of the chair; however, the wheelchair 100 can have a higher rating in other examples by increasing a thickness of the frame (e.g., the fixed frame 102, and a capacity of the scissor lift 154). A series of lift tests were performed, with each data point on the graph representing a test. The plot shows battery life starting at a maximum value at 10 Kg and decreasing to a minimum value at the heaviest weight. The plot of this data closely resembles a straight line. Noteworthy, the plot demonstrates a low trendline slope. That is, battery life only decreased by 33% during the max weight lift tests, which highlights the efficiency of the scissor lift 154, the hinges, and the hydraulic system that drives movement of the wheelchair 100.

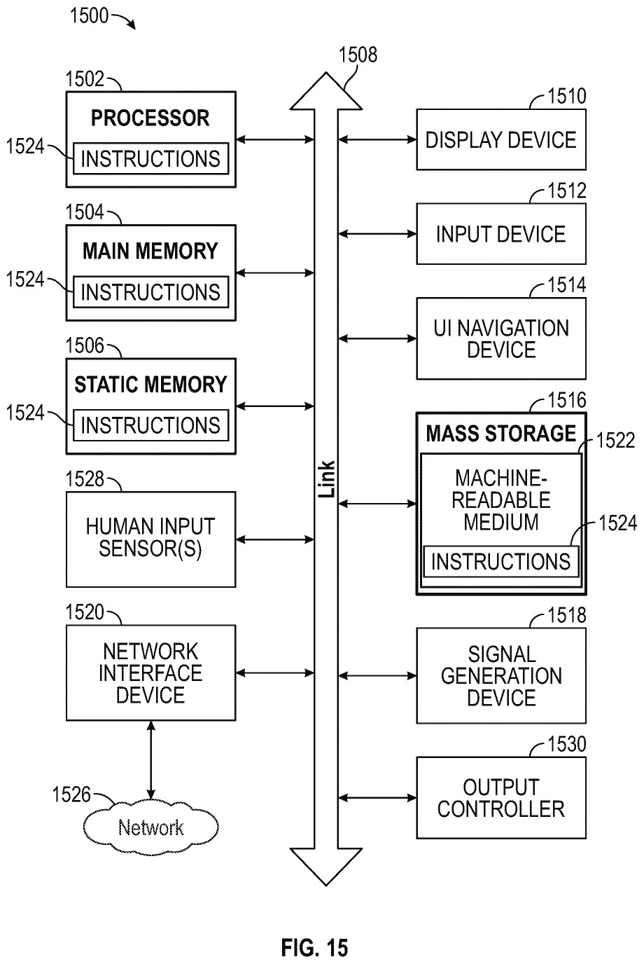

FIG. 15 illustrates a block diagram of an example machine 1500 upon which any one or more of the techniques (e.g., methodologies) discussed herein may perform. Examples, as described herein, may include, or may operate by, logic or a number of components, or mechanisms in the machine 1500. Circuitry (e.g., processing circuitry) is a collection of circuits implemented in tangible entities of the machine 1500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1500 follow.

In alternative embodiments, the machine 1500 may operate as a standalone device or may be connected (e.g., networked) to other machines. In a networked deployment, the machine 1500 may operate in the capacity of a server machine, a client machine, or both in server-client network environments. In an example, the machine 1500 may act as a peer machine in peer-to-peer (P2P) (or other distributed) network environment. The machine 1500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1500 may include a hardware processor 1502 (e.g., a central processing unit (CPU), a graphics processing unit (GPU), a hardware processor core, or any combination thereof), a main memory 1504, a static memory (e.g., memory or storage for firmware, microcode, a basic-input-output (BIOS), unified extensible firmware interface (UEFI), etc.) 1506, and mass storage 1508 (e.g., hard drive, tape drive, flash storage, or other block devices) some or all of which may communicate with each other via an interlink (e.g., bus) 1530. The machine 1500 may further include a display unit 1510, an alphanumeric input device 1512 (e.g., a keyboard), and a user interface (UI) navigation device 1514 (e.g., a mouse). In an example, the display unit 1510, input device 1512 and UI navigation device 1514 may be a touch screen display. The machine 1500 may additionally include a storage device (e.g., drive unit) 1508, a signal generation device 1518 (e.g., a speaker), a network interface device 1520, and one or more sensors 1516, such as a global positioning system (GPS) sensor, compass, accelerometer, or other sensor. The machine 1500 may include an output controller 1528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1502, the main memory 1504, the static memory 1506, or the mass storage 1508 may be, or include, a machine readable medium 1522 on which is stored one or more sets of data structures or instructions 1524 (e.g., software) embodying or utilized by any one or more of the techniques or functions described herein. The instructions 1524 may also reside, completely or at least partially, within any of registers of the processor 1502, the main memory 1504, the static memory 1506, or the mass storage 1508 during execution thereof by the machine 1500. In an example, one or any combination of the hardware processor 1502, the main memory 1504, the static memory 1506, or the mass storage 1508 may constitute the machine readable media 1522. While the machine readable medium 1522 is illustrated as a single medium, the term “machine readable medium” may include a single medium or multiple media (e.g., a centralized or distributed database, and/or associated caches and servers) configured to store the one or more instructions 1524.

The term “machine readable medium” may include any medium that is capable of storing, encoding, or carrying instructions for execution by the machine 1500 and that cause the machine 1500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1524 may be further transmitted or received over a communications network 1526 using a transmission medium via the network interface device 1520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1520 may include one or more physical jacks (e.g., Ethernet, coaxial, or phone jacks) or one or more antennas to connect to the communications network 1526. In an example, the network interface device 1520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1500, and includes digital or analog communications signals or other intangible medium to facilitate communication of such software. A transmission medium is a machine readable medium.

### Notes and Examples

The following, non-limiting examples, detail certain aspects of the present subject matter to solve the challenges and provide the benefits discussed herein, among others.

Example 1 is a lifting and reclining wheelchair comprising: a lower frame; a pair of drive wheels rotatably connected to the lower frame and operable by a user to move the wheelchair about an environment; one or more stabilizer wheels connected to the lower frame; a upper frame connected to the lower frame and movable with respect to the lower frame; a seat connected to the upper frame and movable with the upper frame relative to the lower frame; a backrest connected to the upper frame and movable with the upper frame relative to the lower frame, the backrest configured to recline with respect to the seat; and a hydraulic lift connected to the lower frame and the upper frame and operable to lift the upper frame with respect to the lower frame between a raised position and a lowered position.

In Example 2, the subject matter of Example 1 optionally includes a hydraulic motor connected to the lower frame and operable to drive the hydraulic lift to move the upper frame with respect to the lower frame.

In Example 3, the subject matter of Example 2 optionally includes a pair of backrest hydraulic actuators connected to the seat and the backrest, the hydraulic motor operable to drive the pair of backrest hydraulic actuators to move the backrest relative to the seat between an upright position and a reclined position.

In Example 4, the subject matter of Example 3 optionally includes a pair of leg supports connected to the upper frame and the seat; and a pair of leg support hydraulic actuators connected to the seat and the backrest, the hydraulic motor operable to drive the pair of leg support hydraulic actuators to move the leg supports relative to the seat between a straight position and a seated position.

In Example 5, the subject matter of Example 4 optionally includes a stabilization wheel connected to the lower frame and movable with respect to the lower frame between a stored position and a deployed position; an interlock configured to generate a signal based on whether the stabilization wheel is in the stored position or the deployed position; and a controller configured to prevent the pair of backrest hydraulic actuators from moving to the reclined position when the stabilization wheel is not in the deployed position.

In Example 6, the subject matter of Example 5 optionally includes a stabilization handle manually user-operable to move the stabilization wheel between the stored position and the deployed position.

In Example 7, the subject matter of any one or more of Examples 5-6 optionally include a wireless remote control user operable to communicate with the controller to move the wheelchair between the raised position and the lowered position, to move the pair of leg supports between the straight position and the seated position, and to move the backrest between the upright position and the reclined position.

In Example 8, the subject matter of any one or more of Examples 5-7 optionally include a pair of leg hydraulic valves associated with respective ones of the pair of leg support hydraulic actuators, the pair of leg hydraulic valves hydraulically connected to the hydraulic motor, and the controller operable to control the pair of leg hydraulic valves and the hydraulic motor to move the pair of leg supports between the straight position and the seated position, individually.

In Example 9, the subject matter of Example 8 optionally includes a main hydraulic valve associated with the hydraulic lift, the main hydraulic valve hydraulically connected to the hydraulic motor, and the controller operable to control the main hydraulic valve and the hydraulic motor to move the upper frame between the raised position and the lowered position.

In Example 10, the subject matter of Example 9 optionally includes a backrest hydraulic valve associated with the pair of backrest hydraulic actuators, the backrest hydraulic valve hydraulically connected to the hydraulic motor, and the controller operable to control the backrest hydraulic valve and the hydraulic motor to move the backrest between the upright position and the reclined position.

In Example 11, the subject matter of Example 10 optionally includes an 18 volt direct current battery releasably securable to the lower frame and configured to deliver power to the hydraulic motor and the hydraulic valves.

In Example 12, the subject matter of any one or more of Examples 1-11 optionally include a scissor lift connected to the upper frame, the lower frame, and the hydraulic lift, the scissor lift configured to guide relative movement of the upper frame with respect to the lower frame between the raised position and the lowered position.

In Example 13, the subject matter of Example 12 optionally includes a centrifugal safety connected to the scissor lift and the lower frame, the centrifugal safety configured to limit movement of the upper frame from the raised position to the lowered position when a velocity of the upper frame or the scissor lift exceeds a threshold velocity.

Example 14 is a lifting and reclining wheelchair comprising: a lower frame; a pair of drive wheels rotatably connected to the lower frame and operable by a user to move the wheelchair about an environment; one or more passive wheels connected to the lower frame; a linkage connected to the lower frame and configured to move with respect thereto; a upper frame connected to the lower frame by the linkage; a seat connected to the upper frame and movable with the upper frame relative to the lower frame; a backrest connected to the upper frame and movable with the upper frame relative to the lower frame, the backrest configured to recline with respect to the seat; a hydraulic lift connected to the lower frame and the upper frame; a hydraulic motor connected to the lower frame; and a controller configured to operate the hydraulic motor to drive the hydraulic lift the upper frame with respect to the lower frame between a raised position and a lowered position.

In Example 15, the subject matter of Example 14 optionally includes a pair of backrest hydraulic actuators connected to the seat and the backrest, the controller configured to operate the hydraulic motor to drive the pair of backrest hydraulic actuators to move the backrest relative to the seat between an upright position and a reclined position.

In Example 16, the subject matter of Example 15 optionally includes a pair of leg supports connected to the upper frame and the seat; and a pair of leg support hydraulic actuators connected to the seat and the backrest, the controller configured to operate the hydraulic motor to drive the pair of leg support hydraulic actuators to move the leg supports relative to the seat between a straight position and a seated position.

In Example 17, the subject matter of Example 16 optionally includes a stabilization wheel connected to the lower frame and movable with respect to the lower frame between a stored position and a deployed position; and an interlock configured to generate a signal based on whether the stabilization wheel is in the stored position or the deployed position, the controller configured to prevent the pair of backrest hydraulic actuators from moving to the reclined position when the stabilization wheel is not in the deployed position.

In Example 18, the subject matter of Example 17 optionally includes a stabilization handle manually user-operable to move the stabilization wheel between the stored position and the deployed position.

In Example 19, the subject matter of any one or more of Examples 17-18 optionally include a wireless remote control user operable to communicate with the controller to move the wheelchair between the raised position and the lowered position, to move the pair of leg supports between the straight position and the seated position, and to move the backrest between the upright position and the reclined position.

In Example 20, the subject matter of any one or more of Examples 17-19 optionally include a pair of leg hydraulic valves associated with respective ones of the pair of leg support hydraulic actuators, the pair of leg hydraulic valves hydraulically connected to the hydraulic motor, and the controller operable to control the pair of leg hydraulic valves and the hydraulic motor to move the pair of leg supports between the straight position and the seated position, individually; a main hydraulic valve associated with the hydraulic lift, the main hydraulic valve hydraulically connected to the hydraulic motor, and the controller operable to control the main hydraulic valve and the hydraulic motor to move the upper frame between the raised position and the lowered position; and a backrest hydraulic valve associated with the pair of backrest hydraulic actuators, the backrest hydraulic valve hydraulically connected to the hydraulic motor, and the controller operable to control the backrest hydraulic valve and the hydraulic motor to move the backrest between the upright position and the reclined position.

In Example 21, the apparatuses or method of any one or any combination of Examples 1-20 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A lifting and reclining wheelchair comprising:
a lower frame;
a pair of drive wheels rotatably connected to the lower frame and operable by a user to move the wheelchair about an environment;
one or more stabilizer wheels connected to the lower frame;
a upper frame connected to the lower frame and movable with respect to the lower frame;
a seat connected to the upper frame and movable with the upper frame relative to the lower frame;
a backrest connected to the upper frame and movable with the upper frame relative to the lower frame, the backrest configured to recline with respect to the seat; and
a hydraulic lift connected to the lower frame and the upper frame and operable to lift the upper frame with respect to the lower frame between a raised position and a lowered position.

2. The lifting and reclining wheelchair of claim 1, further comprising:
a hydraulic motor connected to the lower frame and operable to drive the hydraulic lift to move the upper frame with respect to the lower frame.

3. The lifting and reclining wheelchair of claim 2, further comprising:
a pair of backrest hydraulic actuators connected to the seat and the backrest, the hydraulic motor operable to drive the pair of backrest hydraulic actuators to move the backrest relative to the seat between an upright position and a reclined position.

4. The lifting and reclining wheelchair of claim 3, further comprising:
a pair of leg supports connected to the upper frame and the seat; and
a pair of leg support hydraulic actuators connected to the seat and the backrest, the hydraulic motor operable to drive the pair of leg support hydraulic actuators to move the leg supports relative to the seat between a straight position and a seated position.

5. The lifting and reclining wheelchair of claim 4, further comprising:
a stabilization wheel connected to the lower frame and movable with respect to the lower frame between a stored position and a deployed position;
an interlock configured to generate a signal based on whether the stabilization wheel is in the stored position or the deployed position; and
a controller configured to prevent the pair of backrest hydraulic actuators from moving to the reclined position when the stabilization wheel is not in the deployed position.

6. The lifting and reclining wheelchair of claim 5, further comprising:
a stabilization handle manually user-operable to move the stabilization wheel between the stored position and the deployed position.

7. The lifting and reclining wheelchair of claim 5, further comprising:
a wireless remote control user operable to communicate with the controller to move the wheelchair between the raised position and the lowered position, to move the pair of leg supports between the straight position and the seated position, and to move the backrest between the upright position and the reclined position.

8. The lifting and reclining wheelchair of claim 5, comprising:
a pair of leg hydraulic valves associated with respective ones of the pair of leg support hydraulic actuators, the pair of leg hydraulic valves hydraulically connected to the hydraulic motor, and the controller operable to control the pair of leg hydraulic valves and the hydraulic motor to move the pair of leg supports between the straight position and the seated position, individually.

9. The lifting and reclining wheelchair of claim 8, comprising:
a main hydraulic valve associated with the hydraulic lift, the main hydraulic valve hydraulically connected to the hydraulic motor, and the controller operable to control the main hydraulic valve and the hydraulic motor to move the upper frame between the raised position and the lowered position.

10. The lifting and reclining wheelchair of claim 9, comprising:
a backrest hydraulic valve associated with the pair of backrest hydraulic actuators, the backrest hydraulic valve hydraulically connected to the hydraulic motor, and the controller operable to control the backrest hydraulic valve and the hydraulic motor to move the backrest between the upright position and the reclined position.

11. The lifting and reclining wheelchair of claim 10, comprising:
an 18 volt direct current battery releasably securable to the lower frame and configured to deliver power to the hydraulic motor and the hydraulic valves.

12. The lifting and reclining wheelchair of claim 1, comprising:
a scissor lift connected to the upper frame, the lower frame, and the hydraulic lift, the scissor lift configured to guide relative movement of the upper frame with respect to the lower frame between the raised position and the lowered position.

13. The lifting and reclining wheelchair of claim 12, further comprising:
a centrifugal safety connected to the scissor lift and the lower frame, the centrifugal safety configured to limit movement of the upper frame from the raised position to the lowered position when a velocity of the upper frame or the scissor lift exceeds a threshold velocity.

14. A lifting and reclining wheelchair comprising:
a lower frame;
a pair of drive wheels rotatably connected to the lower frame and operable by a user to move the wheelchair about an environment;
one or more passive wheels connected to the lower frame;
a linkage connected to the lower frame and configured to move with respect thereto;
a upper frame connected to the lower frame by the linkage;
a seat connected to the upper frame and movable with the upper frame relative to the lower frame;
a backrest connected to the upper frame and movable with the upper frame relative to the lower frame, the backrest configured to recline with respect to the seat;
a hydraulic lift connected to the lower frame and the upper frame;
a hydraulic motor connected to the lower frame; and
a controller configured to operate the hydraulic motor to drive the hydraulic lift the upper frame with respect to the lower frame between a raised position and a lowered position.

15. The lifting and reclining wheelchair of claim 14, further comprising:
a pair of backrest hydraulic actuators connected to the seat and the backrest, the controller configured to operate the hydraulic motor to drive the pair of backrest hydraulic actuators to move the backrest relative to the seat between an upright position and a reclined position.

16. The lifting and reclining wheelchair of claim 15, further comprising:
a pair of leg supports connected to the upper frame and the seat; and
a pair of leg support hydraulic actuators connected to the seat and the backrest, the controller configured to operate the hydraulic motor to drive the pair of leg support hydraulic actuators to move the leg supports relative to the seat between a straight position and a seated position.

17. The lifting and reclining wheelchair of claim 16, further comprising:
a stabilization wheel connected to the lower frame and movable with respect to the lower frame between a stored position and a deployed position; and
an interlock configured to generate a signal based on whether the stabilization wheel is in the stored position or the deployed position, the controller configured to prevent the pair of backrest hydraulic actuators from moving to the reclined position when the stabilization wheel is not in the deployed position.

18. The lifting and reclining wheelchair of claim 17, further comprising:
a stabilization handle manually user-operable to move the stabilization wheel between the stored position and the deployed position.

19. The lifting and reclining wheelchair of claim 17, further comprising:
a wireless remote control user operable to communicate with the controller to move the wheelchair between the raised position and the lowered position, to move the pair of leg supports between the straight position and the seated position, and to move the backrest between the upright position and the reclined position.

20. The lifting and reclining wheelchair of claim 17, comprising:
a pair of leg hydraulic valves associated with respective ones of the pair of leg support hydraulic actuators, the pair of leg hydraulic valves hydraulically connected to the hydraulic motor, and the controller operable to control the pair of leg hydraulic valves and the hydraulic motor to move the pair of leg supports between the straight position and the seated position, individually;
a main hydraulic valve associated with the hydraulic lift, the main hydraulic valve hydraulically connected to the hydraulic motor, and the controller operable to control the main hydraulic valve and the hydraulic motor to move the upper frame between the raised position and the lowered position; and
a backrest hydraulic valve associated with the pair of backrest hydraulic actuators, the backrest hydraulic valve hydraulically connected to the hydraulic motor, and the controller operable to control the backrest hydraulic valve and the hydraulic motor to move the backrest between the upright position and the reclined position.
